(19) United States
(12) Patent Application Publication
(10) Pub. No.: US 2013/0170414 A1
(43) Pub. Date: Jul. 4, 2013

(54) System and Method for Device-to-Device Communication Overlaid on a Cellular Network

(71) Applicant: Young Hoon Kwon, San Diego, CA (US)

(72) Inventor: Young Hoon Kwon, San Diego, CA (US)

(73) Assignee: FutureWei Technologies, Inc., Plano, TX (US)

(21) Appl. No.: 13/343,554

(22) Filed: Jan. 4, 2012

(51) Int. Cl. H04W 72/04; H04W 52/02

(52) U.S. Cl. 370/311; 370/329

(57) ABSTRACT

An embodiment of a system that operates a user equipment as a serving user equipment in a personal cell. The user equipment is configured to receive a communication resource from a base station to operate as a serving user equipment in a personal cell, the communication resource including a personal cell ID, and transmit in a cellular downlink the personal cell ID and control channel information included in the communication resource to a second user equipment. The communication resource can comprise a downlink of a cellular network for data transmission by the user equipment to the second user equipment. The user equipment retains a cellular communication link to a base station.

### TECHNICAL FIELD

The present invention relates generally to a system and method for digital communications, and more particularly to a system and method for device-to-device operations in a wireless communication system.

### BACKGROUND

In the field of wireless communication, there has been increasing demand for direct device-to-device (“D2D”) communication. Direct device-to-device communication refers to a communication mode between user equipments (“UEs”) that does not include a base station in a communication path between the UEs. D2D communication has the potential to enable a cellular network to offload a portion of its base station traffic. In addition to offloading base-station traffic, D2D communication also enables proximity-based advertisement for local business entities, which can be a revenue source for such entities. D2D communication can also enable an end user of a user equipment to find and identify nearby friends. Ad hoc-type services can also be provided among user equipments that are physically near each other.

Processes to provide performance enhancements for D2D communication would accelerate adoption of this communication form in the marketplace.

A process for a base station to reduce communication with user equipments desiring to communicate with each other without incurring unnecessary cost and overhead would answer an important market need.

### SUMMARY OF THE INVENTION

These and other problems are generally solved or circumvented, and technical advantages are generally achieved, by embodiments of the present invention which provides a system and method for device-to-device operations in a wireless communication system.

In accordance with an example embodiment, a method for a UE to operate in a communications system as a serving UE in a personal cell is provided. The method includes the UE receiving a communication resource from a base station to operate the UE as the serving UE, wherein the communication resource includes a personal cell (“PC”) identifier (“ID”). The UE transmits in a cellular downlink the PC ID and control channel information included in the communication resource to the second UE.

In accordance with a further example embodiment, a method for a base station to enable a UE to operate in a personal cell is provided. The base station transmits a communication resource to a first UE for the first UE to operate as a serving UE in a PC. The communication resource includes a PC ID and another communication resource for a second UE to respond to the PC ID in an uplink to establish a D2D communication link with the first UE. The communication resource transmitted to the UE can be in response to a request from the first UE to operate with D2D communication with the second UE. The communication resource transmitted to the UE includes a downlink resource of a cellular network for transmission of data by the UE to the second UE.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a system drawing showing a base station that communicates conventionally in a cellular network with user equipments and a user equipment that acts as a server in a personal cell, in accordance with an embodiment;

FIG. 2 is a drawing showing timing relationships for coexistence between a personal cell device-to-device communication link and a normal cellular link, in accordance with an embodiment;

FIG. 3 illustrates a graphical representation of a method to operate a user equipment as a serving UE in a personal cell, in accordance with an embodiment;

FIG. 4 illustrates a graphical representation of a method to operate a base station to enable a UE to operate as a serving UE in a personal cell, in accordance with an embodiment; and

FIG. 5 illustrates a block diagram of elements of a processing system that may be used to perform one or more of the processes discussed hereinabove.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Direct device-to-device communication enables a cellular network to offload traffic to a wireless communication path without the need to insert a base station in the communication link between UEs. D2D communication can also enable easy data transfers to and from diverse peripheral devices such as printers, cameras, personal computers, television receivers, . . . , etc., that are colocated in the physical environment of the end user. Nonetheless, cellular operators generally desire to have D2D communications under their control for purposes of billing and accounting, management of carrier frequencies and interference, and overall management of network traffic to optimize available bandwidths.

It would be advantageous for a base station to reduce communication with user equipments desiring to communicate with each other without incurring unnecessary cost. In addition, it would be advantageous for a user equipment to reduce the signaling that is performed when a user equipment desires to establish a D2D communication link with a neighboring user equipment.

In an embodiment, to facilitate D2D communication between end users, a UE is enabled to operate or function temporarily as a personal femtocell base station so that it can communicate with another UE that is within its nearby physical neighborhood. The result creates a “Personal Cell” that enables two UEs to communicate directly with each other without the need to establish a communication path through an evolved base station (“eNB”). One UE operates as if it is an eNB, creating thereby a personal cell (“PC”), a form of a femtocell, and the other UE operates in the served area of the first UE, i.e., in the PC that was created for the first UE. The first UE's data is transmitted on a normal cellular downlink resource, and the second UE's data is transmitted on a normal cellular uplink resource. The eNB allocates and transmits the necessary information and resources to the first UE for the first UE to set up its PC. The eNB may also allocate and transmit necessary information and resources to the second UE to set up the PC.

In a personal cell, one UE operates as a serving UE (a “PCS-UE”), providing thereby a limited functionality of a base station, and one or more PC client UEs (“PCC-UEs”) operate in the personal cell created for the first UE. A PCS-UE is a UE in a PC that acts or functions as an eNB. A PCC-UE is a UE in a PC that acts as a UE. Both the PCS-UE and the PCC-UE retain a direct cellular communication link with their serving eNB. At a given time, both the PCS-UE and the PCC-UE are switched back to normal cellular communication with their respective original cellular eNB.

PC and regular cellular operations may employ a time-division multiplex (“TDM”) or other, e.g., frequency-division multiplex (“FDM”) modulation format.

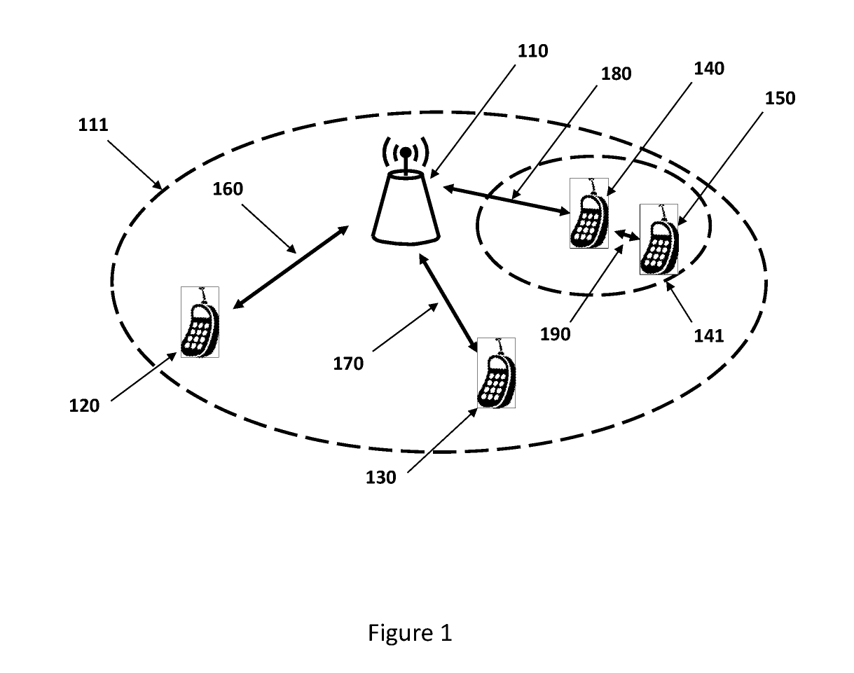

Referring to FIG. 1, illustrated is a system drawing showing an eNB 110 that communicates conventionally in a cellular network with UEs 120, 130, and a serving UE 140 that acts as a PCS-UE, in accordance with an embodiment. The eNB 110 communicates with the conventional UEs 120, 130 over conventional uplink/downlink wireless communication links 160, 170, and with the serving UE 140 over the uplink/downlink wireless communication link 180. The served area of the eNB 110 is indicated by the dashed line 111, and the presumably smaller served area of the serving UE 140 is indicated by the dashed line 141. The serving UE 140 communicates over a D2D wireless communication link 190 with a client UE 150.

In operation, the eNB designates which UE will operate as the PCS-UE and which UE will operate as the PCC-UE. For each D2D grouping, there may be one PCS-UE and one or more PCC-UEs. The eNB's response may be in response to a request from a UE to operate with D2D communication with one or more other UEs. Also, the eNB can initiate D2D communications among UEs in its served area.

The eNB allocates and transmits information that is needed for a personal cell setup such as cell identification (“Cell ID”), a pilot-tone pattern, PC start and stop times, PC carrier frequency, bandwidth to be used for the PC cell, transmitter power level, scheduling rules, etc. During a PC D2D connection, the eNB indicates and updates new scheduling rules and/or transmitter power level to the PCS-UE so that it can operate with better resource utilization and incur less mutual interference among UEs within its served area.

When a UE that desires to operate as a PCS-UE receives information from an eNB about PC setup-related information, the PCS-UE can operate as a normal UE within the served area of the eNB. For example, from time to time the PCS-UE stops transmitting within its own PC and returns to normal cellular network operation to communicate with its serving eNB. The main purpose for the PCS-UE to return to normal cellular network operation may include obtaining an update on the PC scheduling rule, checking if there is any cellular downlink (“DL”) traffic directed to the UE, and transmitting cellular uplink (“UL”) traffic to the eNB that it may desire to originate. The PCS-UE transmits pilot-tone and control channel information with a transmitter power level. The transmitter power level can be predetermined or can be specified by the serving eNB. The PCS-UE prepares access channel reception for possible PCC-UEs with whom it may desire to directly communicate.

Once a PCC-UE successfully accesses a PCS-UE, the PCS-UE schedules downlink and uplink transmissions with its coupled PCC-UE in accordance with resources that can be allocated by its serving eNB, and begins transmission and reception of traffic with the PCC-UE.

When all needed traffic has been exchanged between the PCS-UE and any PCC-UEs, the PCS-UE signals completion of traffic to the serving eNB and to the PCC-UEs to terminate the current D2D link(s).

When a PCC-UE receives information from an eNB about PC setup-related information, the PCC-UE starts a cell acquisition process toward the identified PC. From time to time to PCC-UE returns to its serving eNB for normal cellular communication. Reasons for this communication may include checking if there is any DL traffic for this UE in the cellular network, and transmitting cellular UL traffic that it may need to originate. For the PCC-UE, the PC and the cellular network are transparent to each other except for the PC's pilot tones and control-channel information which is generally transmitted in a discontinuous manner.

When the PCC-UE receives an indication of termination of the D2D link from the PCS-UE, it switches back to normal cellular communication with its serving eNB.

When initiating a D2D link, an eNB allocates a specific cell ID (a “PCell ID”) to the PCS-UE to be used for a given D2D link, and indicates the allocated PCell ID to both the PCS-UE and the PCC-UE. The PCS-UE then transmits the PCell ID and corresponding control channel information in a downlink as if it, the PCS-UE, is just another eNB transmitting a downlink resource. The PCC-UE starts a search for the cell with the broadcasted PCell ID. After the PCC-UE acquires the respective cell with the broadcasted PCell ID, it continues normal cell access procedures employed with normal cellular operation. Accordingly, a normal downlink resource of the cellular network is employed for data transmission from a PCS-UE to a PCC-UE. A normal uplink resource of the cellular network is employed for data transmission from the PCC-UE to the PCS-UE.

Even though PC UEs are directly connected with each other over a D2D communication link, they also retain a cellular connection to a normal cellular network. To allow this feature, the eNB transmits discontinuous receive (“DRX”) and discontinuous transmit (“DTX”) patterns for the PC to use. The eNB allocates both PCS-UE and PCC-UE periodic DRX/DTX patterns for which cellular information is enabled or disabled. The eNB transmits data to a PCS-UE or a PCC-UE during a DRX/DTX off period.

A PCS-UE and a PCC-UE utilize an allocated D2D link during the time when cellular information is not expected to be received or transmitted, i.e., during assigned DRX/DTX off periods. The eNB does not expect any transmitted and received data to and from both the PCS-UE and the PCC-UE to which the D2D link has been allocated.

The PCC-UE generally searches for broadcasted PCell ID during the time period that the D2D link is expected to be used.

When a request to set up a D2D link between a first UE, UE1, and a second UE, UE2, when both are served by a common eNB, the following communication link setup procedure can be employed.

The common eNB transmits an indication to UE1 and UE2 to initiate a D2D link with the following information: designation of which UE is the PCS-UE and which UE is the PCC-UE, Cell ID (PCell ID), and a DRX pattern.

Optionally, the following information can also be transmitted for better performance of the D2D communication link: a pilot pattern, PCell start time and PCell stop time, PCell carrier frequency, PCell bandwidth, transmitter power level, a scheduling rule, etc. During the cellular DRX/DTX “on” duration, UE1 (the PCS-UE) begins transmitting downlink signals with the given PCell ID and corresponding control channel information. During the cellular DRX/DTX “on” duration, UE2 (the PCC-UE) searches for the cell with the given PCell ID and access procedures. After the PCC-UE is connected to the PCS-UE, both the PCS-UE and the PCC-UE continue to transfer data between each other.

During the cellular DRX/DTX “off” duration, both the PCS-UE and the PCC-UE switch to a cellular communication link and receive control channel information from a serving eNB, and continue to use cellular data transmission and reception procedures.

During a following DRX/DTX on duration, both the PCS-UE and the PCC-UE switch to the D2D link and resume direct D2D data transfer between each other. These transmission and reception procedures continue during the duration of a given D2D link.

A D2D communication link can be arranged to allow substantially simultaneous communication, i.e., within the same time slot, among the coupled D2D devices, and between the cellular network and the coupled D2D devices. A process for simultaneous communication includes the assignment of different carrier frequencies for the D2D link other than the carrier frequencies used for the air interface between cellular network and the end-user devices. In this manner the PCS-UE can simultaneously transmit a cellular uplink signal and a D2D downlink signal. The PCS-UE can simultaneously receive a cellular downlink signal and a D2D uplink signal. The PCC-UE can simultaneously transmit a cellular uplink and a D2D uplink signal. And the PCC-UE can simultaneously receive a cellular downlink and a D2D downlink signal.

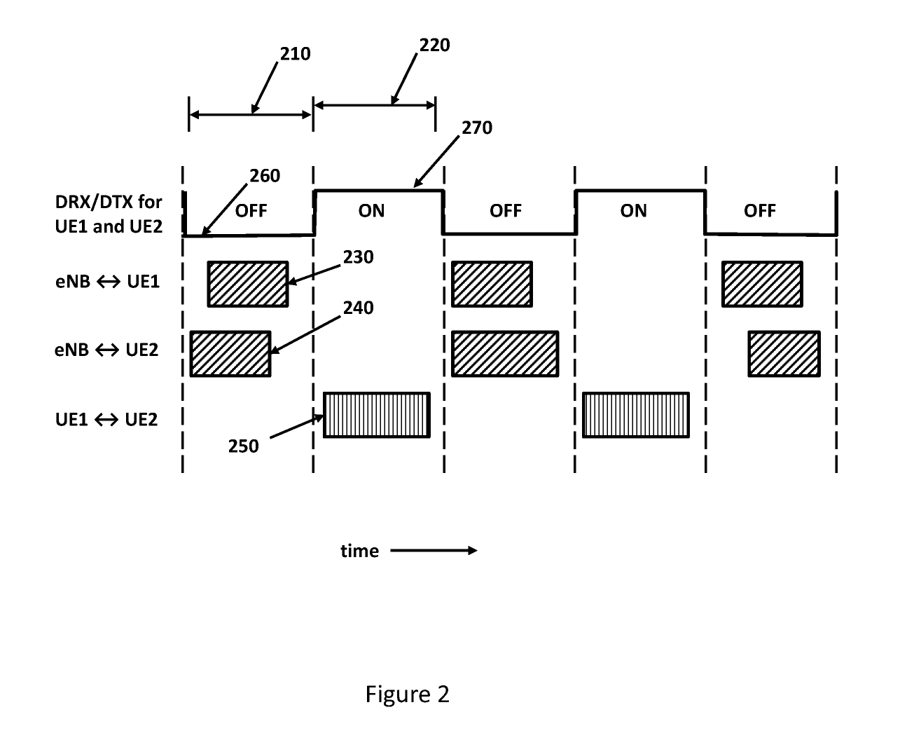

Referring now to FIG. 2, illustrated is a drawing showing timing relationships for coexistence between a PC D2D communication link and a normal cellular link, illustrating an embodiment. Even though PC UEs may be directly connected with each other, they also maintain a communication link to a normal cellular network. To allow this feature, the eNB signals DRX/DTX patterns for this PC. The eNB signals a periodic DRX/DTX pattern to both the PCS-UE and the PCC-UE during which cellular transmissions are enabled and disabled. The PCS-UE and the PCC-UE use the D2D communication link during a timeframe in which cellular transmissions are not expected, i.e., during DRX/DTX “on” durations. The eNB does not expect transmitted and/or received data to and from both the PCS-UE and the PCC-UE when the D2D communication link has been assigned to be enabled. The PCC-UE searches for PCell ID during the time period that the D2D communication link is assigned to be enabled.

In FIG. 2, the time intervals 210, 220 represent frames along a time axis employed for cellular communication between a UE and an eNB. The rectangle 230 represents a group of time slots in the frame 210 employed by an eNB and a first UE, UE1, to communicate on a radio resource in the cellular network. The rectangle 240 represents another group of time slots employed by the eNB and a second UE, UE2, to substantially simultaneously communicate on a different radio resource in the cellular network. The time slots 230 and 240 can overlap in time because the respective communication links are allocated to different frequency resources or are modulated with an orthogonally different pattern. UE1 and UE2 do not communicate over the D2D communication link during the frame 210 as represented by the “off” period 260.

During the “on” period 270, UE1 communicates with UE2 over a D2D communication link. The frame 250 does not overlap the frames 230 and 240, and consequently the UEs can employ the same carrier frequencies for a D2D communication link that may be allocated to UE1 and UE2 to communicate with the eNB. The sequencing of frames 210, 220 can be repeated as illustrated in FIG. 2.

Benefits of enabling a UE to temporarily operate as a base station include an ability to enable simultaneous operation of cellular and D2D communication links in a cellular network. An embodiment enables a cellular operator to have control of D2D links. An embodiment can support D2D communication links with modest modification of current cellular specifications and operation. An eNB can control and manage Cell IDs for D2D usage.

Thus, to set up a D2D link within a cell, an eNB designates one PCS-UE and one or more PCC-UEs for a D2D communication link. The eNB allocates and broadcasts the needed personal cell setup information to the PCS-UE and the PCC-UEs such as Cell ID, on/off period for PC, pilot-tone pattern, PC start time, PC carrier frequency, PCell bandwidth, transmitter power level, scheduling rule, etc. The eNB allocates and transmits the Cell ID to be used for the personal cell.

After the eNB allocates and transmits the Cell ID, the UE designated as the PCS-UE transmits a downlink signal in a downlink resource with the given Cell ID. After the eNB allocates and transmits the Cell ID, a UE(s) designated as the PCC-UE(s) attempts to access the cell with the given Cell ID using a normal cellular procedure. The eNB allocates and transmits a DRX/DTX pattern for both the PCS-UE and the PCC-UE(s). The D2D communication link proceeds during the DRX/DTX on period.

The PCS-UE transmits pilot and control information during the cellular DRX/DTX on period. The PCC-UE searches for the given PCell ID during the cellular DRX/DTX on period. When all needed data traffic is exchanged among the PCS-UE and the PCC-UEs, the PCS-UE requests of the eNB termination of the current D2D link and informs the PCC-UEs. The PCS-UE and the PCC-UEs switch back to normal cellular operation.

D2D and cellular operation can employ different component carriers and the PCS-UE and the PCC-UE can simultaneously transmit and receive both cellular and D2D traffic.

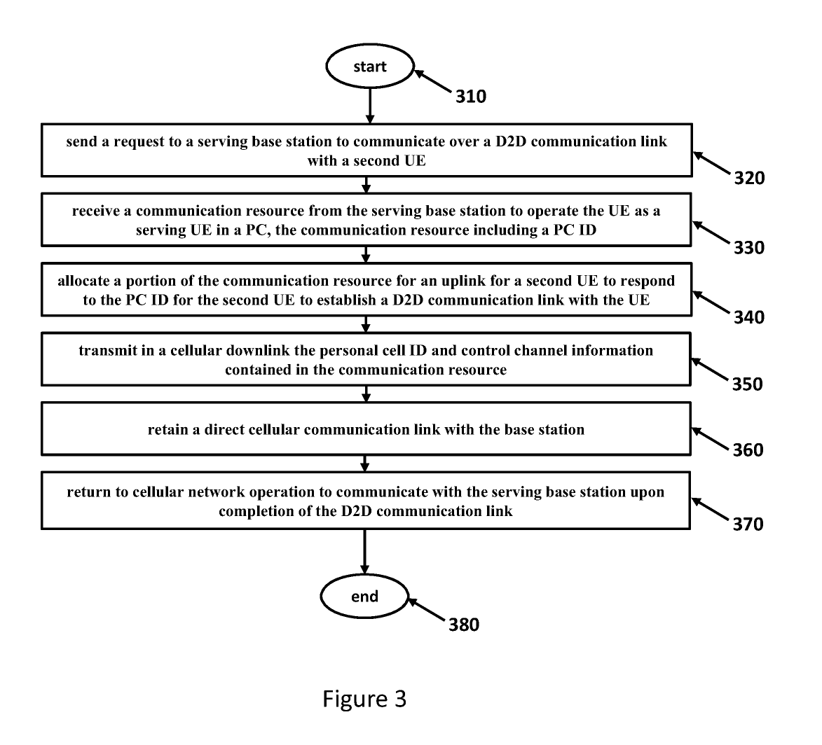

Referring now to FIG. 3, illustrated is a graphical representation of a method to operate a UE as a serving UE in a PC, according to the principles of an embodiment. The method functionally begins in a step or module 310. In step or module 320, the UE sends a request to a serving base station to communicate over a D2D communication link with a second UE. In step or module 330, the UE receives a communication resource from the serving base station to operate as a serving UE in a personal cell, the communication resource including a personal cell ID. The communication resource can include a pilot-tone pattern, a PC start time, a PC stop time, a PC carrier frequency, and an initial UE transmitter power level. The UE can be configured to adjust its own transmitter power level over time. The communication resource received in step or module 330 can be in response to a request from the UE to operate the D2D communication link with the second UE. In step or module 340, the UE allocates a portion of the communication resource for an uplink for the second UE to respond to the personal cell ID to establish a D2D communication link with the UE. In step or module 350, the UE transmits in a cellular downlink the personal cell ID and control channel information contained in the communication resource. The communication resource can be employed in a cellular network downlink for data transmission by the UE to the second UE. In step or module 360 the UE retains a direct cellular communication link with the base station. In step or module 370, upon completion of the D2D communication link, the UE returns to normal cellular network operation to communicate with the serving base station. The UEs can be configured to signal completion of traffic on the D2D communication link to the base station. The method functionally ends in step or module 380.

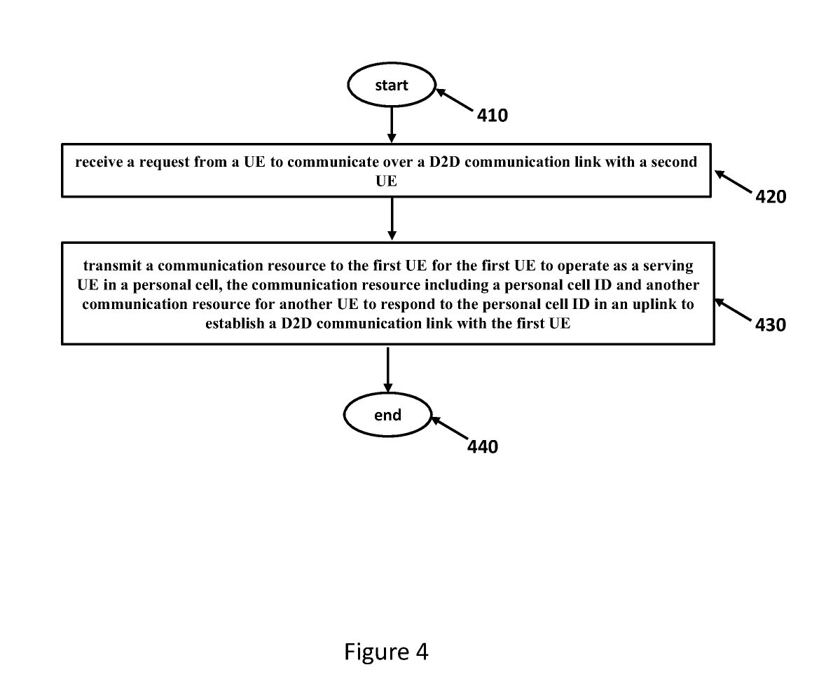

Referring now to FIG. 4, illustrated is a graphical representation of a method to operate a base station to enable a UE to operate as a serving UE in a PC, according to the principles of an embodiment. The method functionally begins in a step or module 410. In step or module 420, the base station receives a request from a UE to communicate over a D2D communication link with a second UE. In step or module 430, in response to the request, the base station transmits a communication resource to the first UE for the first UE to operate as a serving UE in a personal cell, the communication resource including a personal cell ID and another communication resource for the second UE to respond to the personal cell ID in an uplink to establish a D2D communication link with the first UE. The communication resource can include a pilot-tone pattern, a PC start time, a PC stop time, a PC carrier frequency, and an initial transmitter power level for the UE. The communication resource includes a downlink resource of a cellular network for data transmission by the UE to the second UE. The method functionally ends in step or module 440.

Thus, an eNB or the network determines when to initiate a D2D discovery process for end users. Each end user's possible peer user information is stored in the cellular network. Accordingly, each eNB or the network contains peer user information of each UE within its coverage area. A D2D end-user discovery process is initiated when possible end user peers are operating within the same cell coverage area. Use of each UE's geographical location can be employed to improve a possible D2D link set up. Even though UEs are operating within the same cell coverage area, when the distance between these UEs is too far for a D2D link to be set up, they can still communicate with each other using the normal cellular network. The eNB can share BL information with adjacent eNBs so that two UEs operating in in adjacent cells can set up a D2D link when the eNB determines that both UEs are near the cell boundary by checking signal strength between the UEs and the eNBs. In addition to normal end user peers, broadcasting end users can be included in or excluded from in the BL of each UE. Two different types of UEs can be included in their respective BLs. One type is for a peer-to-peer link, and the other type is for broadcasting/multicasting services such as for local advertisements.

Although embodiments described hereinabove operate within the specifications of a cellular communication network such as a 3GPP-LTE cellular network, other wireless communication arrangements are contemplated within the broad scope of an embodiment, including WiMAX, GSM, Wi-Fi, and other wireless communication systems. Accordingly, the term cellular as used herein includes such other wireless communication arrangements and networks.

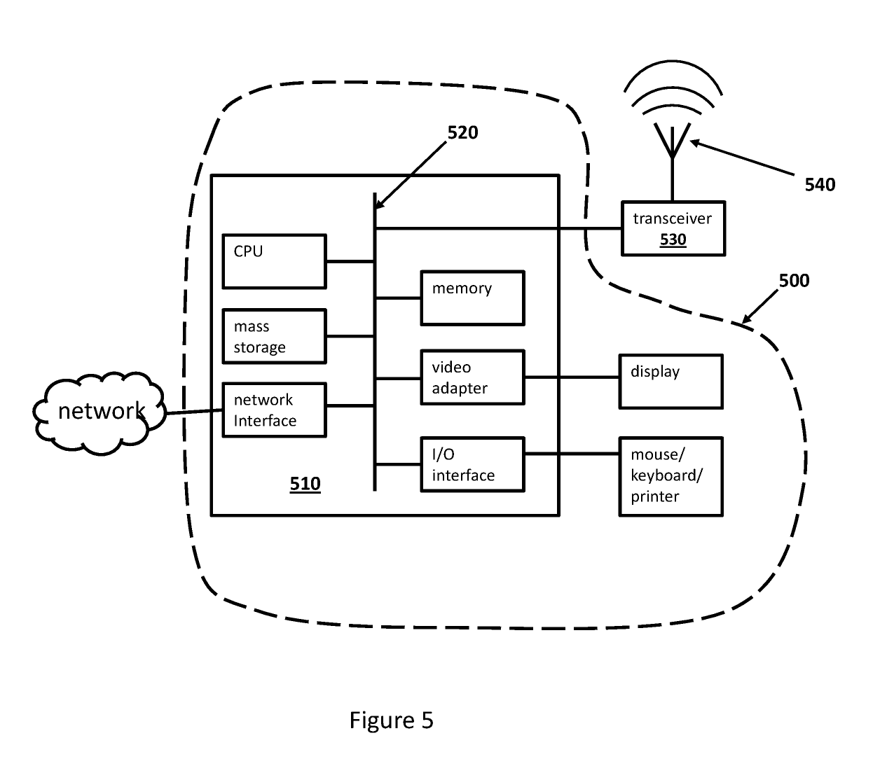

It is noted that, unless indicated otherwise, functions described herein can be performed in either hardware or software, or some combination thereof, with or without human intervention. In an embodiment, the functions are performed by a processor such as a computer or an electronic data processor, such as that discussed hereinbelow with reference to FIG. 5, in accordance with code such as computer program code, software, and/or integrated circuits that are coded to perform such functions, unless indicated otherwise.

Referring now to FIG. 5, illustrated is a block diagram of elements of a processing system 500 that may be used to perform one or more of the processes discussed hereinabove. The processing system 500 may comprise a processor 510 equipped with one or more input/output devices, such as a mouse, a keyboard, a printer, or the like, and a display. The processor 510 may include a central processing unit (CPU), memory, a mass storage device, a video adapter, a network interface, and an I/O interface connected to a bus 520. Certain elements illustrated in FIG. 5 may not be present in certain processing systems, for example, a processing system in a cellular telephone that does not include a printer or network interface.

The bus 520 may be one or more of any type of several bus architectures including a memory bus or memory controller, a peripheral bus, video bus, or the like. The CPU may comprise any type of electronic data processor. The memory may comprise any type of system memory such as static random access memory (SRAM), dynamic random access memory (DRAM), synchronous DRAM (SDRAM), read-only memory (ROM), or mass storage such as a hard drive, a solid-state drive (“SSD”), non-volatile random-access memory (“NVRAM”), optical drive or other storage (which may be local or remote), a combination thereof, or the like. In an embodiment, the memory may include ROM for use at boot-up, and DRAM for data storage for use while executing programs.

A transceiver 530 coupled to an antenna 540 is coupled to the bus 520 to provide a wireless transmitting and a receiving function for the processing system. For example, without limitation, the transceiver 530 may provide a wireless transmitting and receiving function for a cellular communication network.

The mass storage device may comprise any type of storage device configured to store data, programs, and other information and to make the data, programs, and other information accessible via the bus. The mass storage device may comprise, for example, one or more of a hard disk drive, a magnetic disk drive, an optical disk drive, or the like.

The video adapter and the I/O interface provide interfaces to couple external input and output devices to the processor. Examples of input and output devices include the display coupled to the video adapter and the mouse/keyboard/printer coupled to the I/O interface. Other devices may be coupled to the processor, and additional or fewer interface cards may be utilized. For example, a serial interface card (not shown) may be used to provide a serial interface for a printer.

The processor also preferably includes a network interface, which can be a wired link, such as an Ethernet cable or the like, and/or a wireless link to enable communication with a network such as a cellular communication network. The network interface allows the processor to communicate with remote units via the network. In an embodiment, the processor is coupled to a local-area network or a wide-area network to provide communications to remote devices, such as other processors, the Internet, remote storage facilities, or the like.

It should be noted that the processing system may include other components. For example, the processing system may include power supplies, cables, a motherboard, removable storage media, cases, and the like. These other components, although not shown, are considered part of the processing system.

Embodiments such as those presented herein provide a system and a method for operating a UE in a personal cell. For example, embodiments such as those disclosed herein can provide a system constructed with a transceiver and a processor coupled to the transceiver. The processor in conjunction with the transceiver are configured to receive a communication resource from a base station to operate the UE as a serving UE in a PC, wherein the communication resource includes a PC identifier (“ID”) that identifies the personal cell. The UE is configured to transmit in a cellular downlink the PC ID and control channel information included in the communication resource. The communication resource can include a pilot-tone pattern, a PC start time, a PC stop time, a PC carrier frequency, and an initial UE transmitter power level. The processor is further configured to adjust the transmitter power level of the UE. The processor is further configured to transmit the PC ID and the control channel information in the cellular downlink during a cellular DRX/DTX on period. The processor is further configured to retain a cellular communication link between the UE and the base station. The communication resource received from the base station may be in response to a request from the UE to operate the D2D communication link with the second UE. The processor can be further configured to signal completion of traffic on the D2D communication link to the base station. The processor can be further configured to return the UE to normal cellular communication with the base station upon the completion of the traffic on the D2D communication link. The communication resource can comprise a downlink of a cellular network for data transmission by the UE to the second UE.

A further embodiment provides a system and a method for a base station to enable a UE to operate in a personal cell. The base station includes a transceiver and a processor coupled to the transceiver. The processor in conjunction with the transceiver is configured to cause the base station to transmit a communication resource to a first UE for the first UE to operate as a serving UE in a PC. The communication resource includes a PC ID that identifies the personal cell and another communication resource for a second UE to respond to the PC ID in an uplink to establish a D2D communication link with the first UE. The processor in conjunction with the transceiver is further configured to transmit data to the first UE and to the second UE during a DRX/DTX off period. The communication resource may further include a pilot-tone pattern, a PC start time, a PC stop time, a PC carrier frequency, and an initial transmitter power level for the UE. The communication resource transmitted to the UE can be in response to a request from the UE to operate with D2D communication with the second UE. The communication resource transmitted to the UE includes a downlink resource of a cellular network for data transmission by the UE to the second UE.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A user equipment, comprising:
a transceiver; and
a processor coupled to the transceiver, the processor, in conjunction with the transceiver, configured to:
receive an allocation of a communication resource from a base station to function as a serving user equipment (“UE”) in a personal cell (“PC”), the communication resource including a PC identifier (“ID”) that identifies the personal cell, and
transmit in a cellular downlink the PC ID and control channel information included in the communication resource.

2. The user equipment as recited in claim 1 wherein the communication resource further includes at least one of a pilot-tone pattern, a PC start time, a PC stop time, a PC carrier frequency, and an initial user equipment transmitter power level.

3. The user equipment as recited in claim 2 wherein the processor is further configured to adjust the user equipment transmitter power level.

4. The user equipment as recited in claim 1 wherein the user equipment transmits the PC ID and the control channel information in the cellular downlink during a cellular DRX/DTX on period.

5. The user equipment as recited in claim 1 wherein the processor is further configured to retain a cellular communication link with the base station.

6. The user equipment as recited in claim 1 wherein the communication resource received from the base station is in response to a request from the user equipment to operate the D2D communication link with the another UE.

7. The user equipment as recited in claim 1 wherein the processor is further configured to signal completion of traffic on the D2D communication link to the base station.

8. The user equipment as recited in claim 7 wherein the processor is further configured to return the user equipment to normal cellular communication with the base station upon the completion of the traffic on the D2D communication link.

9. The user equipment as recited in claim 1 wherein the communication resource comprises a downlink of a cellular network for data transmission by the user equipment to the another UE.

10. A base station, comprising:
a transceiver; and
a processor coupled to the transceiver, the processor, in conjunction with the transceiver, configured to cause the base station to transmit a communication resource to a first UE for the first UE to operate as a serving UE in a PC, the communication resource including a PC ID and another communication resource for another UE to respond to the PC ID in an uplink to establish a D2D communication link with the first UE.

11. The base station as recited in claim 10 wherein the processor in conjunction with the transceiver are further configured to transmit data to the first UE and to the another UE during a DRX/DTX off period.

12. The base station as recited in claim 10 wherein the communication resource further includes at least one of a pilot-tone pattern, a PC start time, a PC stop time, a PC carrier frequency, and an initial transmitter power level for the UE.

13. The base station as recited in claim 10 wherein the communication resource transmitted to the UE is in response to a request from the UE to operate with D2D communication with the another UE.

14. The base station as recited in claim 10 wherein the communication resource transmitted to the UE includes a downlink resource of a cellular network for data transmission by the UE to the another UE.

15. A method comprising:
receiving by a user equipment a communication resource from a base station to operate the user equipment as a serving UE in a PC, the communication resource including a PC ID; and
transmitting in a cellular downlink the personal cell ID and control channel information contained in the communication resource.

16. The method as recited in claim 15, wherein the communication resource received by the user equipment from the base station is in response to a request by the user equipment to communicate over a D2D communication link with the second UE.

17. The method as recited in claim 15, further comprising retaining a direct cellular communication link by the user equipment with the base station.

18. The method as recited in claim 15, further comprising the user equipment returning to a cellular network operation to communicate with the base station upon completion of the D2D communication link.

19. The method as recited in claim 15, further comprising employing a downlink resource of a cellular network for data transmission to the second UE.

20. A method for base station operations, the method comprising transmitting a communication resource to a first UE for the first UE to function as a serving UE in a PC, the communication resource including a PC ID and a communication resource for another UE to respond to the PC ID in an uplink to establish a D2D communication link with the first UE.

21. The method as recited in claim 20, wherein the communication resource transmitted to the first UE is in response to a request from the first UE to operate with a D2D communication link with the another UE.

22. The method as recited in claim 20, wherein the communication resource transmitted to the first UE includes a downlink resource of a cellular network for data transmission by the first UE to the another UE.
